(19) United States
(12) Patent Application Publication
(10) Pub. No.: US 2005/0018994 A1
(43) Pub. Date: Jan. 27, 2005

(54) Active and passive to-can extension boards

(75) Inventors: Majid Leonard Riaziat, San Jose, CA (US); Mark Adams, Mountain View, CA (US)

Correspondence Address: WILSON SONSINI GOODRICH & ROSATI, 650 PAGE MILL ROAD, PALO ALTO, CA, 943041050, US

(73) Assignee: OEpic, Inc., Sunnyvale, CA (US)

(21) Appl. No.: 10/663,358

(22) Filed: Sep. 15, 2003

Related U.S. Application Data
(60) Provisional application No. 60/490,039, filed on Jul. 24, 2003.

(51) Int. Cl. G02B 6/00

(52) U.S. Cl. 385/147

(57) ABSTRACT

An apparatus can include a TO-can and an optoelectronic device. An extension board, such as a rigid board or extension board, can be connected to the TO-can. The board can connected to a printed circuit board. Variants can mount an integrated circuit on the extension board, connect the external surface of the TO-can to the board, and/or use a rigid extension board.

### CROSS-REFERENCE TO RELATED APPLICATIONS

This application claims priority to U.S. Provisional Application No. 60/490,039, filed on Jul. 24, 2003 and U.S. Provisional Application No. 60/410,354, filed Sep. 13, 2002, which are incorporated herein by reference in their entirety.

### BACKGROUND

10 Gbps lasers can be packaged together with their drivers in butterfly and/or Mini-DIL type packages with fiber pigtails. Lower frequency lasers can be packaged in TO-cans while the laser driver is placed on a printed circuit board and connected to the laser via a transmission line.

Butterfly and Mini-DIL packages can be relatively expensive. They may not lend themselves well to devices such as receptacle type fiber interfaces used in datacom applications.

TO-cans are a less expensive alternative. In some cases, the TO-can is mounted on the edge of the printed circuit board, with its axis parallel to the board. This mounting arrangement saves space and conforms to small form factor packaging and line-card requirements.

FIGS. 1A and 1B show such mounting of the TO-can at the edge of a printed circuit board. There is a gap between the TO-can and the edge of the board. This gap is often on the order of one millimeter.

For 10 Gbps TO-cans, the gap should be as close to zero as possible. Any additional lead inductance, particularly in the ground path, can significantly degrade the signal.

When mounting TO-cans on the printed circuit board, a ground pad can be placed very close to the TO-can's ground pin at the edge of the printed circuit board, as shown in FIG. 2. A soldered connection of the ground pin should touch or almost touch the body of the TO-can.

FIG. 5 shows an example of a problematic apparatus. A TO-can is connected to a flexible board and in turn to a printed circuit board. Shown are a TO-can 510, a flexible extension board 520 connected to TO-can 510, and a printed circuit board 530 connected to the flexible extension board 620. Shown are posts 560 extending from the interior of the TO-can 510 to the flexible extension board 520.

Placing a driver chip on the printed circuit board and connecting it with a transmission line to the laser inside the TO-can may be acceptable for lower frequencies. However, the transmission line connection can force the driver to provide a high voltage swing. The extra voltage swing tends to slow down the circuit and places a heavier burden on the circuit design for higher frequencies. It also increases the power consumption of the driver chip.

Thus, TO-can packages can be directly soldered to printed circuit boards. High-speed TO-cans should be soldered to printed circuit boards with a minimum offset distance between the TO-can and the printed circuit board. Mounting to the edge of the board can result in too few contact footprints allowed to the printed circuit board and/or difficulty in making a reliable, low-inductance ground contact between the TO-can and the printed circuit board.

It would thus be desirable to incorporate active integrated circuits, such as laser drivers, and optoelectronic TO-can packages in a manner that alleviates high frequency performance, voltage, and/or power issues.

### SUMMARY

Some embodiments include an optoelectronic TO-can and a board.

The optoelectronic TO-can can have at least an external surface. The optoelectronic TO-can can include a TO-can and an optoelectronic device. The TO-can can have a width. The optoelectronic device can be in the TO-can and can have an optical axis.

The board can be, for example, an extension board, such as a rigid board or a flexible board. The board can be connected to the optoelectronic TO-can, and can have a width less than twice the width of the TO-can.

In some embodiments, the board can include multiple portions, such as a TO-can portion proximate to the TO-can, and a printed circuit board portion proximate to the printed circuit board. The TO-can portion can be positioned at least substantially perpendicular to the optical axis of the optoelectronic device in the TO-can. The printed circuit board portion can be positioned at least substantially parallel to the optical axis of the optoelectronic device in the TO-can.

In some embodiments, the board include surfaces. One surface can face toward the optoelectronic TO-can. Another surface can face away from the optoelectronic TO-can.

The extension board can include sets of contacts. Sets of contacts can located on one or both surfaces of the board. A set of one or more contacts can be positioned to connect to a printed circuit board. The printed circuit board can be positioned at least substantially parallel to the optical axis of the optoelectronic device in the TO-can. Another set of one or more contacts can be positioned to connect to the optoelectronic TO-can.

Some embodiments include an integrated circuit. The integrated circuit can be mounted on the board. The integrated circuit can be coupled to at least one contact of the first set of one or more contacts. The integrated circuit also can be coupled to at least one contact of the second set of one or more contacts.

Some embodiments can include one or more electrical connections between at least the external surface of the optoelectronic TO-can to the TO-can portion of the flexible board. Some embodiments are an optoelectronic module, such as a transponder or transceiver.

### BRIEF DESCRIPTION OF THE FIGURES

FIGS. 1A and 1B show an example of a printed circuit board assembly of a TO-can.

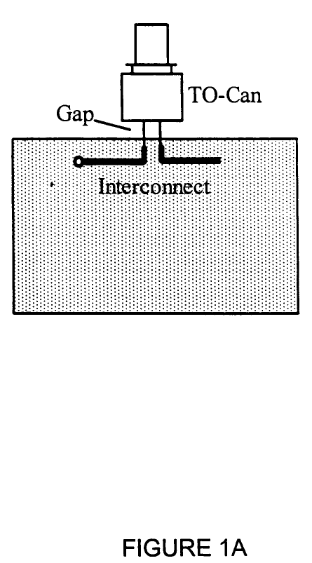

FIG. 2 shows an example of a TO-can connected to a ground contact on the printed circuit board.

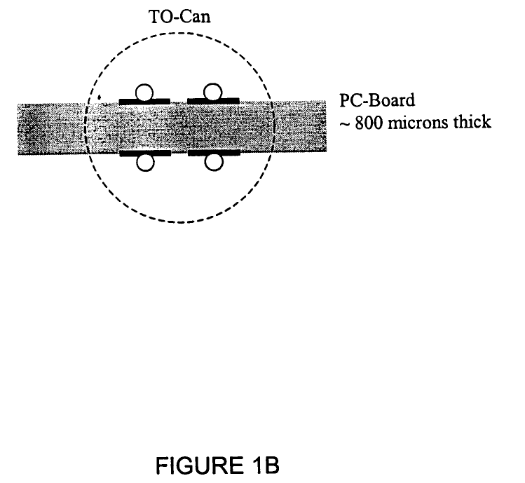

FIG. 3 shows a circuit with design trade-offs between voltage swing versus impedance in a circuit driving a laser.

FIG. 4 shows an example of coplanar waveguide transmission line.

FIG. 5 shows an example of a TO-can connected to a flexible board and in turn to a printed circuit board.

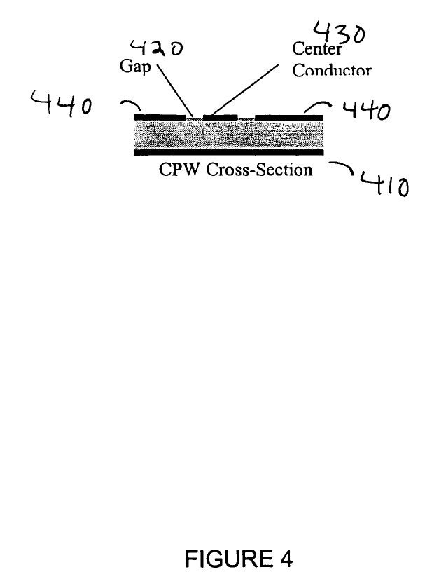

FIGS. 6A and 6B show an example of directly grounding a flexible board to an exterior of the TO-can.

FIGS. 7A and 7B show an example of directly grounding a rigid board to an exterior of the TO-can.

FIG. 8 shows another example of directly grounding a flexible board to an exterior of the TO-can.

FIG. 9 shows an example of an integrated circuit mounted on a flexible board.

FIG. 10 shows an example of an integrated circuit mounted on a rigid board.

FIG. 11 shows an example of a planar view of an integrated circuit mounted on a flexible board.

### DETAILED DESCRIPTION OF THE INVENTION

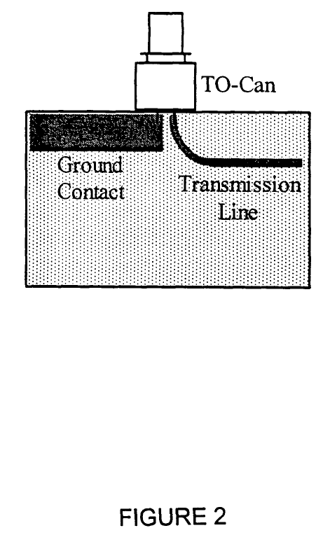

FIG. 3 shows a circuit driving a laser. Direct modulation of a DFB or a Fabry-Perot laser is typically done by a driver integrated circuit chip that modulates the bias current of the laser. Dynamic resistance of the bias port is between 5 and 10 ohms for most such lasers. If the driver IC is placed in close proximity to the laser, it can provide the required current modulation very effectively through a low impedance connection. The resulting voltage swing ΔV at the output of the IC will be the Z=5 to 10 ohm impedance of the laser multiplied by the required current swing ΔI:
ΔV=Z·ΔI

For example, for a current swing of 80 mA peak to peak, the maximum required voltage swing will be 800 mV, which is quite manageable in circuit design. If the physical distance between the driver IC and the laser is significant, then a transmission line with well-defined impedance can be used to connect the two. However, rather than a 5-10 ohm transmission line, (which can be difficult to built or deal with), the most commonly used transmission line impedance is 50 ohms. Using a 50-ohm transmission line can require the addition of enough matching resistance to the laser to bring its impedance up to 50 ohms.

In such a 50-ohm system, the required voltage swing and power consumption in the IC can be high. In the example above, the required voltage swing will be as high as 4.0 V, which is quite high for a fast IC. As a compromise, many manufacturers choose a 25-ohm system that will reduce the required voltage swing by 50% or 2.0V in this example. Still, for performance and/or power consumption reasons, it can be desirable to reduce the distance between the driver and the laser so that a low impedance interface can be used. If the laser is placed in a small TO-can as required by many 10 Gbps datacom packages, there is insufficient room for both the laser and the driver to coexist in the same TO-can package.

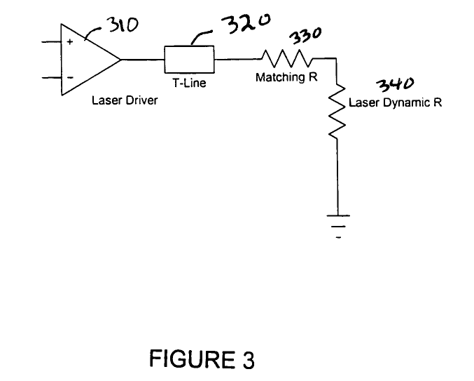

Interconnects on the printed circuit board should be designed as microstrip (MS), coplanar waveguide (CPW) or other 50-ohm transmission lines with well-defined grounding. FIG. 4 shows an example of coplanar waveguide transmission line. The following table lists the dimensions of a few 50-ohm CPW lines on a 200-micron, RO4350 material (Rogers trademark).

| Center-Conductor Width (μm) | Gap (μm) |
|---|---|
| 50 | |
| 75 | 7 |
| 100 | 10 |

With the prior steps, the necessity of using differential signal lines can be reduced. However, if an application requires differential signals, it is essential to maintain geometrical symmetry between the differential lines. Unequal lengths, and parasitic reactances of the signal lines can destroy the balance of the differential signal.

This technology allows high-speed (10 Gbps and higher) fiber optic transmitters and receivers to be packages in low-cost TO-cans.

The “transistor outline package” or the “TO-can” with optical windows can house optoelectronic semiconductor devices, including optoelectronic receivers such as photodetectors, and optoelectronic transmitters such as laser diodes. Although the TO-can was not originally intended to be used with high-speed modulation, the modulation rate of devices in TO-Cans has steadily increased over the years. Small TO-cans such as TO-46 can be used in optoelectronic packaging at data rates as high as 2.5 and 3.3 Gbps. Some embodiments include even faster TO-can packages. Optoelectronic transmit and receive modules in “internally matched” TO-cans can operate at data rates as high as 12.5 Gbps. From an end user's point of view, the internally matched TO can be identical to a standard TO-46 package. However, the electrical transition between the printed circuit board and the package requires some attention. Improved approaches for mounting the TO-can on a printed circuit board can ensure the integrity of high-speed signals at the transition with the printed circuit board.

The TO-can has a width of the distance from one edge of the exterior of the TO-can through the center of the TO-can to opposing edge of TO-can. For example, the width of a TO-can with a circular base is the diameter of the base, and the width of a TO-can with a rectangular base is the shorter of the lengths of the base.

Some embodiments include high-speed (10 Gbps and higher) fiber optic transmitters and receivers packaged with TO-Cans.

Extension boards are adapters of high-speed TO-can packages to printed circuit boards. Extension boards include flexible boards and rigid boards. Ground contact between the extension board and TO-can is made by, e.g. a rigid solder connection. Electrical connections such as ground between the extension board and the optoelectronic TO-can include, for example, conductive epoxy, solder, allow, and/or metal.

The signal and bias leads of the can be attached to the extension where they are distributed to any desired footprint for connection to the printed circuit board. High-speed signal leads can be routed to the printed circuit board through e.g. a 50-ohm or other impedance transmission line.

The extension board can increase the functionality of TO-cans, such as a TO-46 type package which has a limited number of posts to connect to the outside world, and therefore limited functionality. The extension board can effectively increase the number of leads associated with the TO-can, and even move some functionality off of the printed circuit board and onto the extension board.

Flexible extension boards (flexboards) can connect the TO-can to the printed circuit board at lower frequencies. The provisions listed above can be addressed automatically with the use of the flexboard. However, proper grounding is also necessary. The ground pin of the TO-can can be connected to the CPW transmission-line ground on the flexboard. This type of connection has the parasitic inductance of the ground pin through the flexboard.

Some embodiments mount an integrated circuit such as the laser driver on an extension board such as the flexboard. The board is attached to the back of the TO-can housing the laser. This allows the laser to have a short and low-impedance connection to the integrated circuit.

Direct grounding of the back of the board (e.g., microstrip ground) to the body of the TO-can improves performance.

Rigid extension boards can also connect a TO-can to a printed circuit board. Rigid extension boards offer similar advantages and lend themselves better to the addition of active devices such as integrated circuits (e.g., laser drivers) with minimal connection distance to the TO-can.

Directly connecting the extension board to the TO-can to ground the extension board to the optoelectronic TO-can external surface, e.g. the TO-can base, can be done with, e.g. conductive epoxy and/or solder. The conductive connection is made to the external surface of the TO-can. The external surface of the TO-can may include minor projections or depressions of the TO-can. For example, a short electrical post which extends outside the TO-can by no more than 1 mm is part of the TO-can external surface.

Other embodiments assemble electronic integrated circuits in close proximity to optoelectronic transmitters and/or receivers.

An integrated circuit, such as a laser driver, chip including circuitry processing signals received from an optoelectronic receiver, or optical transmitter driver generally, can be mounted on a flexboard or rigid board that is attached to the back of the TO-can that houses the optoelectronic device, such as a laser. This allows the laser to have a short and low-impedance connection to the laser driver. A mounted IC can be electrically connected via e.g. wire bonding, flipchip mounting, soldering contact pad, conductive epoxy, etc. The integrated circuit can be mounted on a surface facing away from the optoelectronic TO-can.

The same technique can be used to assemble other electronic integrated circuits in close proximity to optoelectronic transmitters or receivers that they need to interface with. The technique is beneficial to any application which is harmed by distance.

The extension board can dissipate the heat generated by the mounted IC.

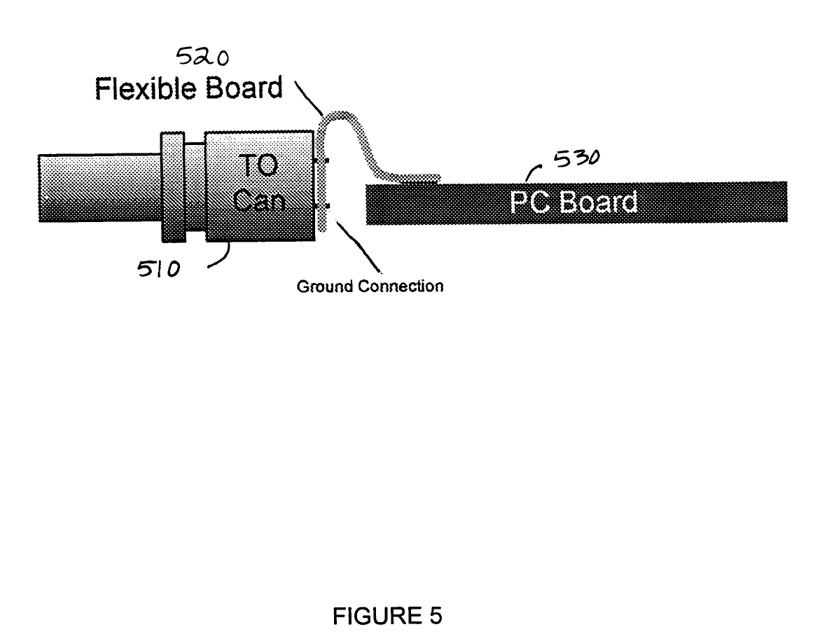

FIGS. 6A and 6B show an example of directly grounding a flexible board to an external surface of an optoelectronic TO-can. FIG. 6A shows a side view, and FIG. 6B shows a back view. Shown are a TO-can 610, a flexible extension board 620 connected to TO-can 610, and a printed circuit board 630 connected to the flexible extension board 620. In a gap between the TO-can 610 and the flexible extension board 620, an electrical connection 660 connects the external surface of the optoelectronic TO-can 610 and the flexible extension board 620. Also shown are contacts 670 electrically connecting the flexible extension board 620 to the printed circuit board 630. These contacts are shown as solder contacts, though other types of contacts can be used. Also shown are contacts 680 electrically connecting the flexible extension board 620 to the TO-can 610.

A flexible board can have at least a printed circuit board portion and a TO-can portion. The printed circuit board portion includes the portion of the flexible board proximate to the printed circuit board, and the TO-can portion includes the portion of the flexible board proximate to the TO-can.

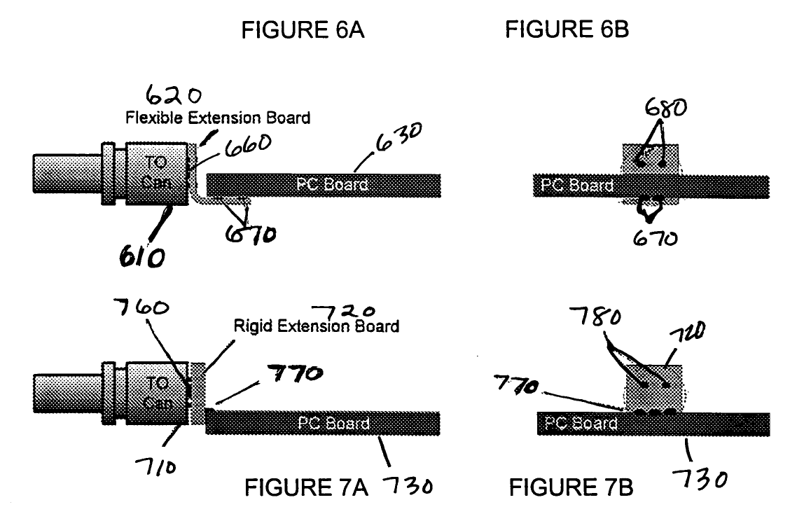

FIGS. 7A and 7B show an example of directly grounding a rigid board to an external surface of optoelectronic TO-can. FIG. 7A shows a side view, and FIG. 7B shows a back view. Shown are a TO-can 710, a rigid extension board 720 connected to TO-can 710, and a printed circuit board 730 connected to the rigid extension board 720. In a gap between the TO-can 710 and the rigid extension board 720, an electrical connection 760 connects the external surface of the optoelectronic TO-can 710 and the rigid extension board 720. Such a connection can serve as a ground contact. Also shown are contacts 770 electrically connecting the rigid extension board 720 to the printed circuit board 730. These contacts are shown as pin contacts, though other types of contacts can be used. Also shown are contacts 780 electrically connecting the rigid extension board 720 to the TO-can 710.

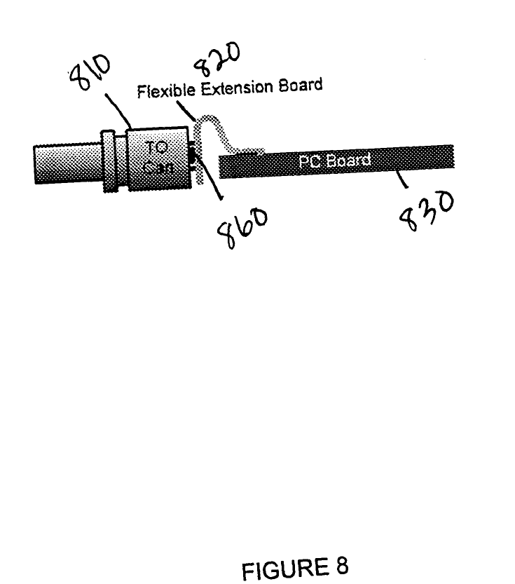

FIG. 8 shows another example of directly grounding a flexible board to an external surface of optoelectronic TO-can. Shown are a TO-can 810, a flexible extension board 820 connected to TO-can 810, and a printed circuit board 830 connected to the flexible extension board 820. In a gap between the TO-can 810 and the flexible extension board 820, an electrical connection 860 connects the external surface of the TO-can 810 and the flexible extension board 820.

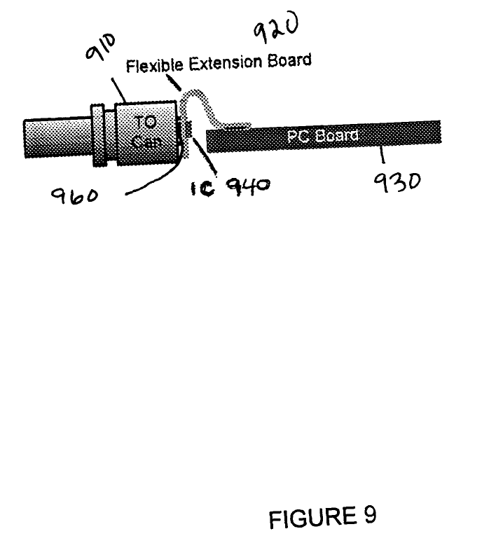

FIG. 9 shows an example of an integrated circuit mounted on a flexible board. Shown are a TO-can 910, a flexible extension board 920 connected to TO-can 910, and a printed circuit board 930 connected to the flexible extension board 920. An integrated circuit 940 is mounted on the flexible extension board 920. In a gap between the TO-can 910 and the flexible extension board 920, an electrical connection 960 connects the external surface of the TO-can 910 and the flexible extension board 920.

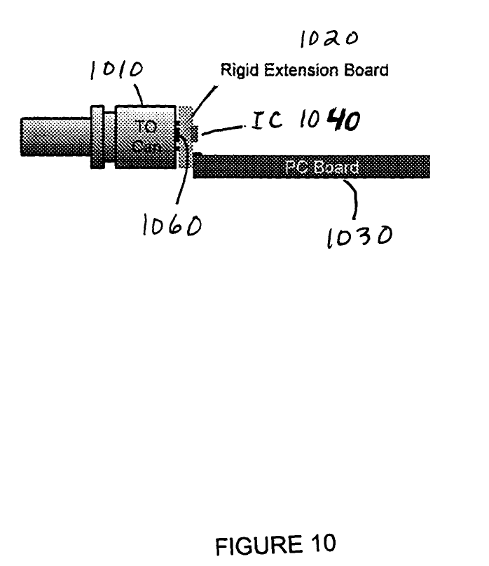

FIG. 10 shows an example of an integrated circuit mounted on a rigid board. Shown are a TO-can 1010, a rigid extension board 1020 connected to TO-can 1010, and a printed circuit board 1030 connected to the rigid extension board 1020. An integrated circuit 1040 is mounted on the rigid extension board 1020. In a gap between the TO-can 1010 and the rigid extension board 1020, an electrical connection 1060 connects the external surface of the TO-can 1010 and the rigid extension board 1020.

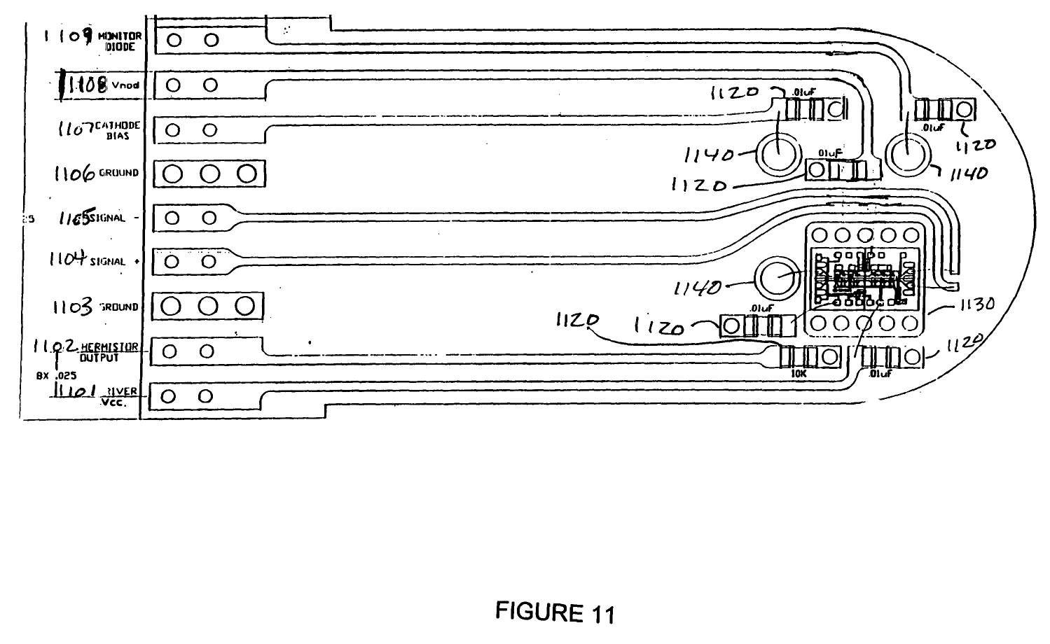

FIG. 11 shows an example of a planar view of an integrated circuit mounted on a flexible board. Shown are the traces: driver Vcc 1101, thermistor output 1102, ground 1103, signal+1104, signal−1105, ground 1106, cathode bias 1107, Vnod 1108, and monitor diode 1109. Shown are capacitors 1120, connected to the traces: driver Vcc 1101, thermistor output 1102, cathode bias 1107, Vnod 1108, and monitor diode 1109. Contacts 1140 are electrically connected to the optoelectronic TO-can. Contacts 1140 are connected to the traces: cathode bias 1107 and monitor diode 1109. Integrated circuit 1130 is connected to a capacitor 1120, a contact 1140, and to traces: driver Vcc 1101, signal+1104, signal−1105, and Vnod 1108. In this planar view, distances in the plane of the paper are considered lateral distances. In some embodiments where an integrated circuit is mounted on a surface of an extension board, the lateral distance between the integrated circuit and the optoelectronic TO-can can be less than twice the width of the TO-can.

1. An apparatus comprising:
an optoelectronic TO-can having at least an external surface, the optoelectronic TO-can including:
a TO-can having a width; and
an optoelectronic device in the TO-can, the optoelectronic device having an optical axis; and
an extension board connected to the optoelectronic TO-can, the extension board having a width less than twice the width of the TO-can, the extension board including:
a first set of one or more contacts positioned to connect to a printed circuit board positioned at least substantially parallel to the optical axis of the optoelectronic device in the TO-can;
a second set of one or more contacts positioned to connect to the optoelectronic TO-can; and
an integrated circuit mounted on the extension board, the integrated circuit coupled to at least one contact of the first set of one or more contacts and at least one contact of the second set of one or more contacts.

2. The apparatus of claim 1, wherein a lateral distance on a surface of the extension board between the integrated circuit and the optoelectronic TO-can is less than twice the width of the TO-can.

3. The apparatus of claim 2, wherein the integrated circuit is mounted on the surface of the extension board facing away from the optoelectronic TO-can.

4. The apparatus of claim 1, wherein the optoelectronic device includes an optoelectronic receiver.

5. The apparatus of claim 4, wherein the integrated circuit includes circuitry processing one or more signals received from the optoelectronic receiver.

6. The apparatus of claim 1, wherein the optoelectronic device includes an optoelectronic transmitter.

7. The apparatus of claim 6, wherein the integrated circuit includes an optical transmitter driver.

8. The apparatus of claim 1, wherein the extension board includes a rigid board.

9. The apparatus of claim 1, wherein the extension board includes a flexible board.

10. The apparatus of claim 1, further comprising:
one or more electrical connections between at least the external surface of the optoelectronic TO-can to the extension board, wherein the one or more electrical connections ground the extension board to the external surface of the optoelectronic TO-can.

11. The apparatus of claim 10, wherein at least one of the one or more electrical connections occupy a gap between the optoelectronic TO-can and the extension board connected to the optoelectronic TO-can.

12. The apparatus of claim 1, further comprising:
the printed circuit board.

13. An apparatus comprising:
an optoelectronic TO-can having at least an external surface, the optoelectronic TO-can including:
a TO-can having a width; and
an optoelectronic device in the TO-can, the optoelectronic device having an optical axis;
a flexible board having a width less than twice the width of the TO-can, the flexible board including:
a TO-can portion positioned at least substantially perpendicular to the optical axis of the optoelectronic device in the TO-can;
a printed circuit board portion positioned at least substantially parallel to the optical axis of the optoelectronic device in the TO-can; and
one or more contacts on the printed circuit board portion, the one or more contacts positioned to connect to a printed circuit board positioned at least substantially parallel to the optical axis of the optoelectronic device in the TO-can; and
one or more electrical connections between at least the external surface of the optoelectronic TO-can to the TO-can portion of the flexible board.

14. The apparatus of claim 13, wherein the optoelectronic device includes an optoelectronic receiver.

15. The apparatus of claim 14, wherein the optoelectronic device includes an optoelectronic transmitter.

16. The apparatus of claim 13, wherein at least one of the one or more conductive connections includes conductive epoxy.

17. The apparatus of claim 13, wherein at least one of the one or more conductive connections includes at least one of solder, alloy, and metal.

18. The apparatus of claim 13, wherein the one or more conductive connections ground the flexible board to the external surface of the optoelectronic TO-can.

19. The apparatus of claim 18, wherein the one or more conductive connections ground a surface of the flexible board to the external surface of the optoelectronic TO-can, the surface of the flexible board facing toward the optoelectronic TO-can.

20. The apparatus of claim 13, further comprising:
an integrated circuit mounted on the flexible board.

21. The apparatus of claim 13, wherein at least one of the one or more electrical connections occupy a gap between the optoelectronic TO-can and the flexible board connected to the optoelectronic TO-can.

22. The apparatus of claim 13, further comprising:
the printed circuit board.

23. An apparatus comprising:
an optoelectronic TO-can having at least an external surface, the optoelectronic TO-can including:
a TO-can having a width; and
an optoelectronic device in the TO-can, the optoelectronic device having an optical axis; and
a rigid board connected to the optoelectronic TO-can, the rigid board positioned at least substantially perpendicular to the optical axis of the optoelectronic device in the TO-can, the rigid board having a width less than twice the width of the TO-can, the rigid board including:
a first surface facing toward the optoelectronic TO-can;
a second surface facing away from the optoelectronic TO-can;
a first set of one or more contacts on the first surface, the first set of one or more contacts positioned to connect to the optoelectronic TO-can; and
a second set of one or more contacts on the second surface, the second set of one or more contacts positioned to connect to a printed circuit board positioned at least substantially parallel to the optical axis of the optoelectronic device in the TO-can.

24. The apparatus of claim 23, wherein the optoelectronic device includes an optoelectronic receiver.

25. The apparatus of claim 23, wherein the optoelectronic device includes an optoelectronic transmitter.

26. The apparatus of claim 23, further comprising:
an integrated circuit mounted on the rigid board.

27. The apparatus of claim 23, further comprising:
one or more electrical connections between at least the external surface of the optoelectronic TO-can to the rigid board, wherein the one or more electrical connections ground the rigid board to the external surface of the optoelectronic TO-can.

28. The apparatus of claim 27, wherein at least one of the one or more electrical connections occupy a gap between the optoelectronic TO-can and the rigid board connected to the optoelectronic TO-can.

29. The apparatus of claim 23, further comprising:
the printed circuit board.

30. An apparatus comprising:
an optoelectronic module comprising:
an optoelectronic TO-can having at least an external surface, the optoelectronic TO-can including:
a TO-can having a width; and
an optoelectronic device in the TO-can, the optoelectronic device having an optical axis; and
an extension board connected to the optoelectronic TO-can, the extension board having a width less than twice the width of the TO-can, the extension board including:
a first set of one or more contacts positioned to connect to a printed circuit board positioned at least substantially parallel to the optical axis of the optoelectronic device in the TO-can;
a second set of one or more contacts positioned to connect to the optoelectronic TO-can; and
an integrated circuit mounted on the extension board, the integrated circuit coupled to at least one contact of the first set of one or more contacts and at least one contact of the second set of one or more contacts.

31. The apparatus of claim 30, wherein the optoelectronic module includes an optoelectronic transceiver.

32. The apparatus of claim 30, wherein the optoelectronic module includes an optoelectronic transponder.

33. An apparatus comprising:
an optoelectronic module comprising:
an optoelectronic TO-can having at least an external surface, the optoelectronic TO-can including:
a TO-can having a width; and
an optoelectronic device in the TO-can, the optoelectronic device having an optical axis;
a flexible board having a width less than twice the width of the TO-can, the flexible board including:
a TO-can portion positioned at least substantially perpendicular to the optical axis of the optoelectronic device in the TO-can;
a printed circuit board portion positioned at least substantially parallel to the optical axis of the optoelectronic device in the TO-can; and
one or more contacts on the printed circuit board portion, the one or more contacts positioned to connect to a printed circuit board positioned at least substantially parallel to the optical axis of the optoelectronic device in the TO-can; and
one or more electrical connections between at least the external surface of the optoelectronic TO-can to the TO-can portion of the flexible board.

34. The apparatus of claim 33, wherein the optoelectronic module includes an optoelectronic transceiver.

35. The apparatus of claim 33, wherein the optoelectronic module includes an optoelectronic transponder.

36. An apparatus comprising:
an optoelectronic module comprising:
an optoelectronic TO-can having at least an external surface, the optoelectronic TO-can including:
a TO-can having a width; and
an optoelectronic device in the TO-can, the optoelectronic device having an optical axis; and
a rigid board connected to the optoelectronic TO-can, the rigid board positioned at least substantially perpendicular to the optical axis of the optoelectronic device in the TO-can, the rigid board having a width less than twice the width of the TO-can, the rigid board including:
a first surface facing toward the optoelectronic TO-can;
a second surface facing away from the optoelectronic TO-can;
a first set of one or more contacts on the first surface, the first set of one or more contacts positioned to connect to the optoelectronic TO-can; and
a second set of one or more contacts on the second surface, the second set of one or more contacts positioned to connect to a printed circuit board positioned at least substantially parallel to the optical axis of the optoelectronic device in the TO-can.

37. The apparatus of claim 36, wherein the optoelectronic module includes an optoelectronic transceiver.

38. The apparatus of claim 36, wherein the optoelectronic module includes an optoelectronic transponder.
